(19) United States
(12) Patent Application Publication
(10) Pub. No.: US 2005/0278231 A1
(43) Pub. Date: Dec. 15, 2005

(54) Method of recovery of electronic shopping cart information for reinitiation of the check-out process

(76) Inventor: Tobias A. Teeter, Kansas City, MO (US)

Correspondence Address: CHASE LAW FIRM L.C, 4400 COLLEGE BOULEVARD, SUITE 130, OVERLAND PARK, KS, 66211, US

(21) Appl. No.: 11/151,754

(22) Filed: Jun. 14, 2005

Related U.S. Application Data
(60) Provisional application No. 60/579,509, filed on Jun. 15, 2004.

(51) Int. Cl. G06F 17/60

(52) U.S. Cl. 705/26

(57) ABSTRACT

The present invention provides a method of saving a shopping cart and associated consumer information independently and if subsequently abandoned, automatically prompting the abandoned shopper with an e-mail message or other electronic communication to reinitiate the checkout process from a hyperlink in the e-mail message or other form of communication.

### CROSS REFERENCE TO RELATED APPLICATION

This application claims the benefit of a prior filed, co-pending application Ser. No. 60/579,509, filed Jun. 15, 2004, entitled SYSTEM THAT CAPTURES AND REDIRECTS ELECTRONIC SHOPPING CART INFORMATION SUBMITTED DURING AN E-COMMERCE WEBSITE SESSION INTO AN ELECTRONIC MESSAGE THAT IS SENT TO THE SHOPPER UPON THE SESSION ENDING WITHOUT COMPLETING THE ONLINE TRANSACTION, THE ELECTRONIC MESSAGE WILL CONTAIN A HYPERTEXT LINK BACK TO THE E-COMMERCE WEBSITE, WHICH WILL TRIGGER A RENEWAL OF THE SESSION AND REPOPULATE THE ELECTRONIC SHOPPING CART INFORMATION FOR REINITIATION OF THE CHECK-OUT PROCESS.

### FIELD OF THE INVENTION

The present invention relates to E-commerce, and more particularly, to a method of collecting consumer information and shopping cart information for subsequent presentation to the consumer to reinitiate the checkout process if the shopping cart is abandoned by the consumer.

### BACKGROUND OF THE INVENTION

Electronic commerce or E-commerce has become increasingly popular. The number of online shoppers who purchase something has steadily increased from approximately 3.5 percent in 2003 to over four percent in 2004. When online shoppers select an item for purchase, the item is placed in an electronic or virtual “shopping cart” which temporarily stores the shopper's selections in a persistent data storage file stored either on the merchant's server or locally on a shopper's computer. The locally stored file is often called a “cookie.” The cookie is saved in a temporary directory on the shopper's hard drive and is often automatically deleted periodically. If the shopper leaves the website before the sale is completed, the content of the shopping cart becomes abandoned.

It has been estimated that between 25 and 78 percent of online shoppers abandon their online shopping carts before making purchases. This correlates to the estimate that for every dollar of revenue made from sales online, shopping cart abandonment results in nearly five dollars of lost revenue.

Various recommendations have been proposed to reduce the occurrence of shopping cart abandonment such as reducing the number of steps a shopper must take from start to finish (see U.S. Pat. No. 5,960,411); lowering shipping costs; requesting less information early in the process; addressing privacy and security issues; improving usability and design of the website and user interface; and improving server response time, to name a few examples. Each of these recommendations attempts to minimize or prevent shopping cart abandonment but ignores the abandoned shopping cart itself and ways to recover those lost sales.

### SUMMARY OF THE INVENTION

The present invention provides a method of saving a shopping cart and associated consumer information independently and if subsequently abandoned, automatically prompting the abandoned shopper with an e-mail message or other electronic communication to reinitiate the checkout process from a hyperlink in the e-mail message or other form of communication.

### BRIEF DESCRIPTION OF THE DRAWINGS

FIGS. 1A-1D are functional block diagrams of the process of the present invention.

FIG. 2 is a diagram of an information collected configuration screen.

FIG. 3 is a diagram of an e-mail configuration screen.

### DETAILED DESCRIPTION

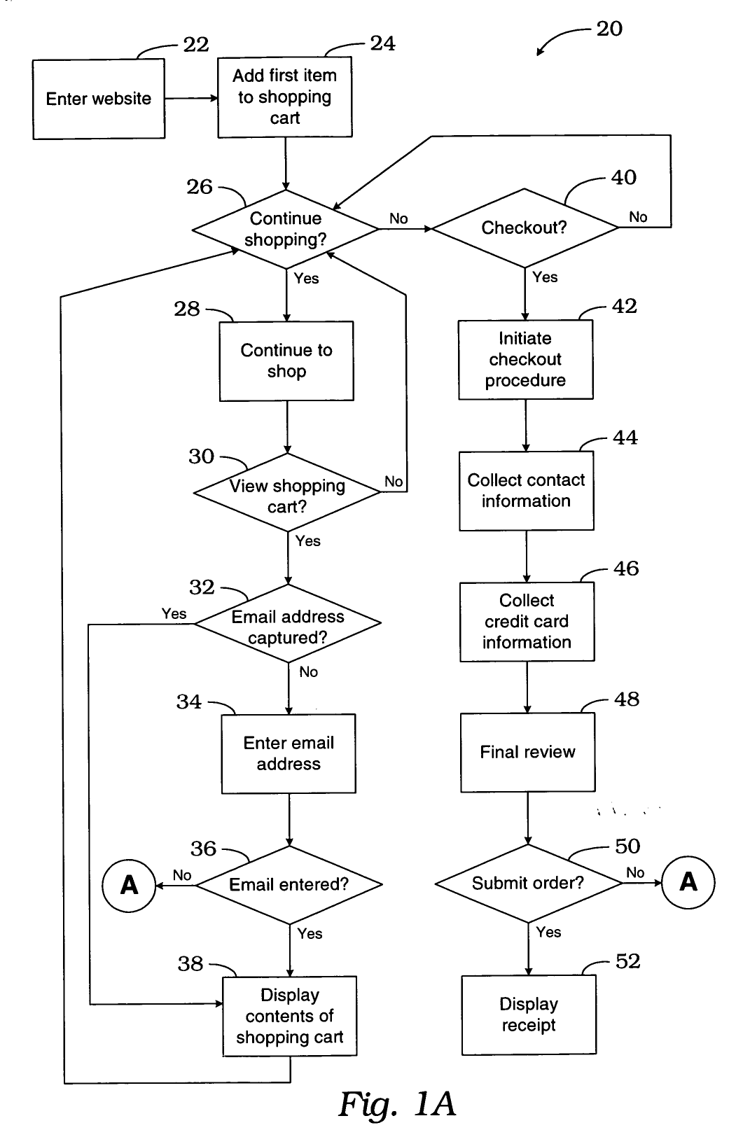

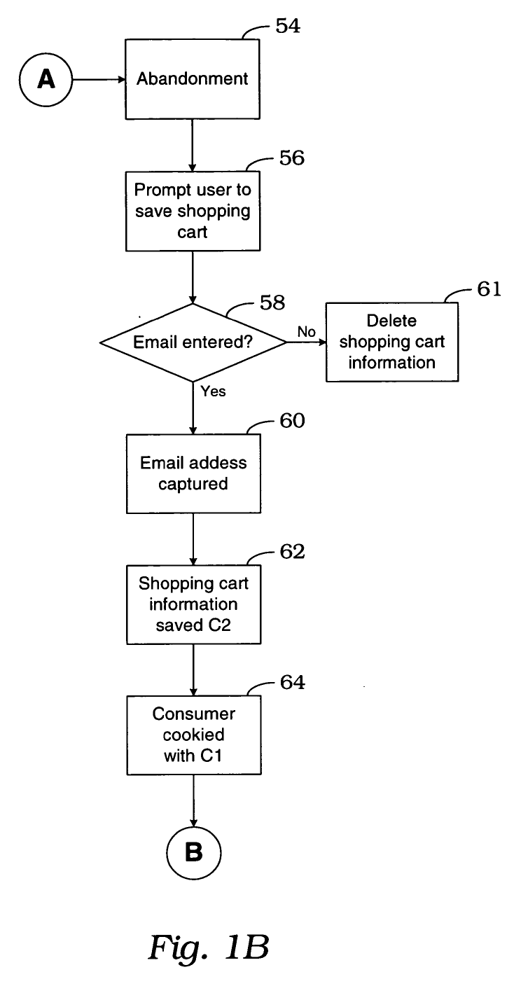

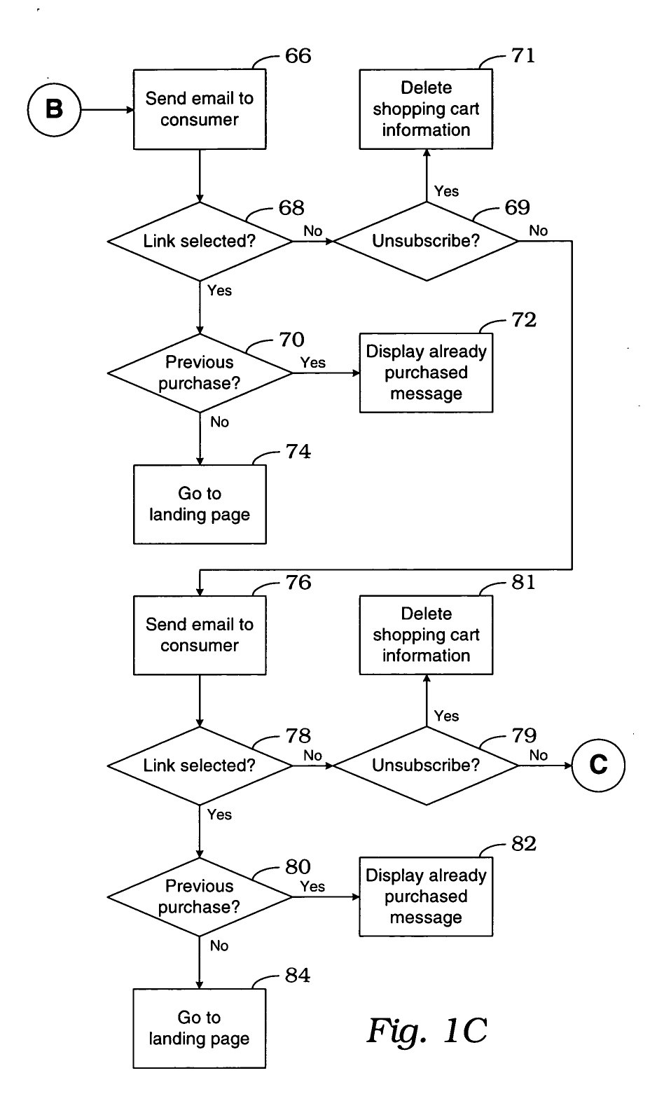

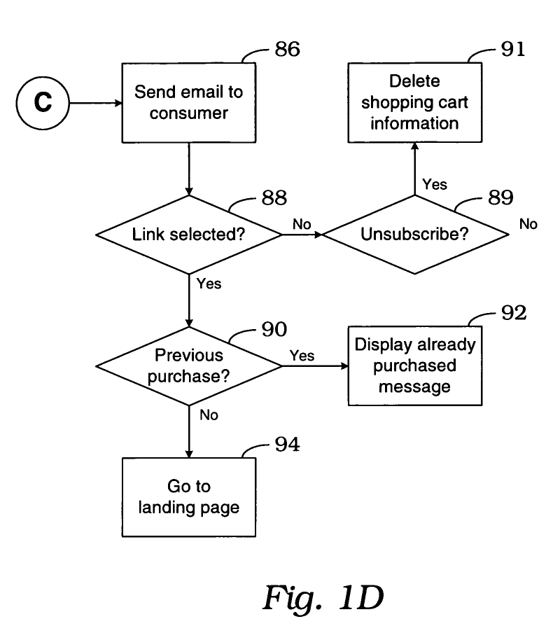

Referring to FIG. 1, a function block diagram of the method of the present invention is generally identified by reference numeral 20. The process begins with the online consumer entering an e-commerce website, block 22. The consumer locates an item for purchase and adds the first item to a shopping cart, block 24. If the consumer decides to continue to shop, decision block 26, the consumer may continue to browse the website and may add additional items to the shopping cart, block 28.

If the consumer decides to check out, decision block 40, the check out procedure is initiated, block 42. Contact information is collected, block 44, credit card or other payment information is collected, block 46, and the consumer is presented with a final review of the items to be purchased and the associated cost, block 48. If the consumer submits the order, decision block 50, the information collected is verified and an order receipt and thank you page is displayed, block 52. If the consumer decides not to submit the order, decision block 50, processing may return to decision block 26.

At any point in the process, the consumer may abandon the shopping cart by closing the browser window currently displaying the e-commerce website, or may simply go to another website for example. If the consumer abandons the shopping cart before entering an e-mail address, block 54, a popup window may be displayed upon a website exit prompting the consumer to save the shopping cart by entering an e-mail address, block 56. At this point the consumer's e-mail address is captured for later use, block 60 as described hereinbelow. If the consumer does not enter an e-mail address, decision block 58, and leaves the website, the shopping cart is stored on a server, block 62.

The consumer's e-mail address can be successfully captured prior to abandonment by a number of methods, including (1) from the e-commerce website's checkout or site registration e-mail address collection form field, (2) via a cookie placed from a prior site visit, (3) from a prior site visit by a previously registered consumer that logged in during the current session, or (4) from a data collection panel presented during the session via a pop up window or hidden <div> element block hosted by either the e-commerce website or a 3^{rd} party application service provider (ASP). If the consumer abandons the shopping cart after entering an e-mail address, the e-mail address is collected, block 60, the shopping cart information C2 is stored on a server, block 62, and a cookie or other persistent client-side data file C1 is placed on the consumer's computer hard drive, block 64. Cookie C1 contains a reference id of the customer's information and shopping cart that correlates to the shopping cart information stored on the server which is used if the consumer later returns to the ecommerce website to complete the purchase of the items placed in the shopping cart, or to continue shopping and modify the contents of the shopping cart.

If the e-mail address was successfully captured upon abandonment, a personalized e-mail is sent to the consumer, block 66, containing the shopping cart information which was stored on the session server and a hypertext link to initiate the checkout process. If the consumer clicks on the hypertext link, the shopping cart is reinitiated on the e-commerce web site. The consumer is also provided with an unsubscribe link. If the consumer chooses to unsubscribe from future emails, decision block 69, the consumer's e-mail address is added to the server's no e-mail list to prevent future emails, block 71.

If the hypertext link is not selected, decision block 68, and the consumer has not chosen to unsubscribe, decision block 69, a second e-mail is sent, block 76, containing a message again encouraging the consumer to complete the purchase and includes a hypertext link to initiate the checkout process. If the consumer selects the hyperlink, decision block 78, the consumer is directed to the landing page to initiate the check out process, block 84. If the consumer chooses to unsubscribe, decision block 79, the consumer's e-mail address is removed from the server's valid e-mail list block 81.

If the hypertext link is again not selected, decision block 78, a third e-mail may be sent, block 86 containing another message to encourage the consumer to complete the purchase of the items contained in the shopping cart and a hypertext link to initiate the checkout process. If the consumer clicks on the hypertext link, the consumer is redirected to the checkout process, block 94. If the consumer chooses to unsubscribe, decision block 89, the consumer's e-mail address is removed from the server's valid e-mail list block 91.

The above described process provides ecommerce merchants with a second chance to get consumers to complete their sales. It enables a consumer to recover an abandoned shopping cart hours or even days later and then complete their order resulting in an increase in revenue for the merchant. The process collects the consumer's shopping data and e-mail address. If the consumer does not complete the order, one or more e-mails are sent to the consumer at intervals selected by the merchant. The e-mail may contain a personalized message from the merchant as well as an incentive offer such as a coupon and contains a hypertext link for the consumer to return to the merchant's website and complete the purchase. By selecting the link, the contents of the consumer's shopping cart, prior to abandonment, are again accessible and the consumer may modify or add to the contents, or proceed directly to checkout.

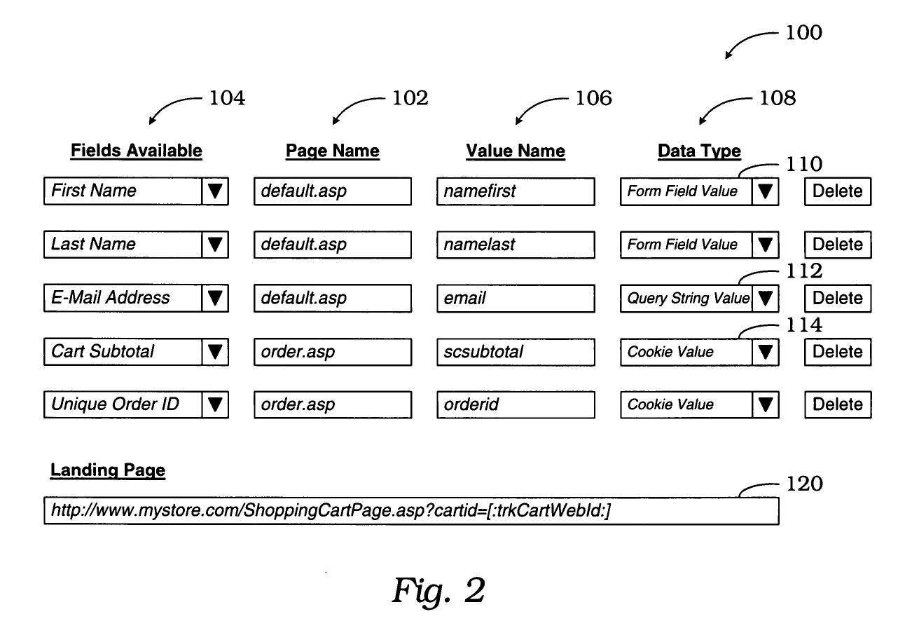

Referring to FIG. 2, the process may be enabled by first creating a map of the web pages from which the system will collect information. In order to track a consumer and shopping cart, information such as first name, last name, e-mail address, shopping cart subtotal, unique cart identifier, unique order identifier and successful order completion may be collected. Additional information such as address, city, state, zip code, phone, or products viewed may also be collected.

From an information collection screen 100 the web page name 102 for a field to be collected 104 is entered along with the field value name 106 and associate data type 108. The web page name 102 is the name of the web page, such as index.html, which contains the field 104, such as first name, to be collected. The value name 106, such as first_name or fname, is the actual variable name used in the web page for the field 104. The data type 108 may be a form field value 110, a query string value 112 or a cookie value 114.

Form fields 110 are HTML elements inside <form> tags such as a text box, text area, select box, or hidden text. To collect information in a form field 110, the type of information is selected from the fields available select box 104, the web page name 102, such as index.html, is entered, the field name is entered in the value name box 106, and Form Field Value 110 is selected in the data type select box 108.

Query string values 112 are information passed through the URL address of the web page. For example, in the URL address http://www.mysite.com/defaultasp?name1=value1& name2=value2, the query string information is everything after the question mark (?). To have this information collected, the type of information is selected from the fields available select box 104, the web page name 102 is entered, the left part of each name/value pair is entered in the value name box 106, and Query String Value 112 is selected in the data type select box 108. For the URL address http://vww.mysite.com/default.asp?name1=value1&name2=value2, name1 is one collection value and name2 is a second collection value.

Cookie values 114 are pieces of text information that an E-commerce website server sends to a consumer's browser for later usage. Because browser software allows the user to control acceptance of cookies with the option to block cookies, use of cookie values 114 to recover the contents of a shopping cart may be unreliable. Cookies may be set through scripting either located on the web-based server or by JavaScripting on the E-commerce client. In order to collect cookie information, the type of information is selected from the fields available select box 104, the web page name 102 is entered, the name of the cookie is entered in the value name field 106, and Cookie Value 114 is selected in the data type select box 108.

The landing page URL address 120 is the web page where the shopper will be redirected from the hyperlink within the e-mail to retrieve their shopping cart. The cartid is used in the link to retrieve the shopper's cart information from the e-commerce web site's server. The web page address entered can direct the abandoner to whatever page the merchant chooses though usually will be the shopping cart review page so that the contents of the abandoner's shopping cart may be recovered and the order placed.

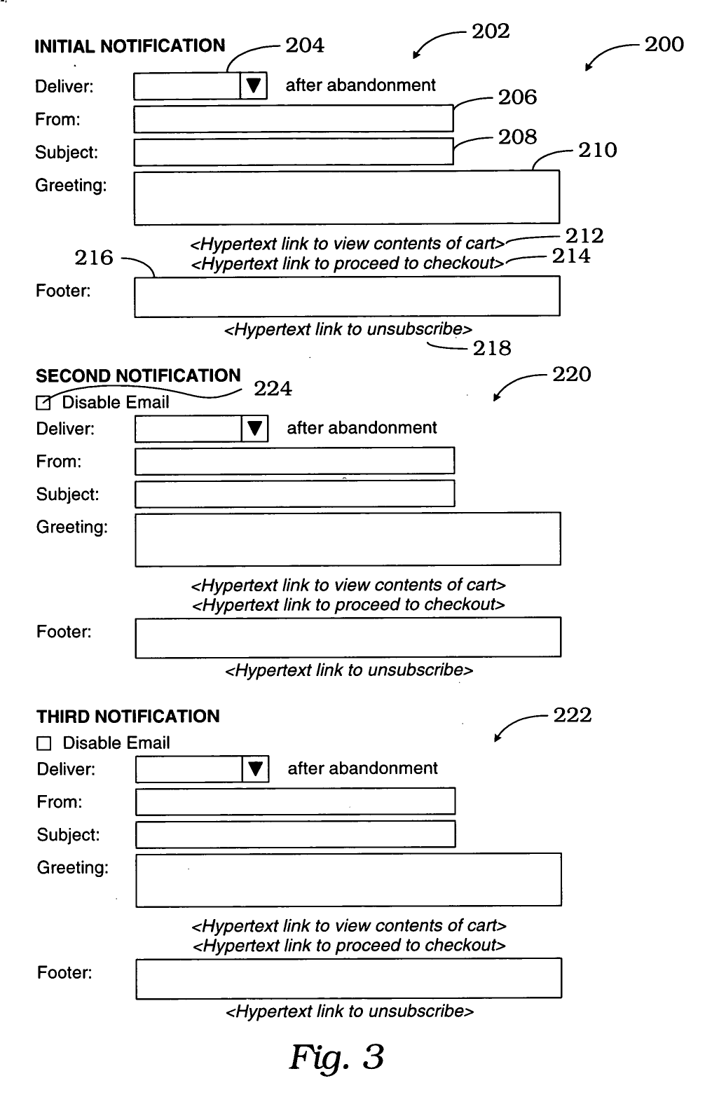

Referring to FIG. 3, the number and timing of the e-mails to be sent to the shopping cart abandoners may be configured in the e-mail configuration screen, generally indicated by reference numeral 200. For example, the initial e-mail configuration 202, may be set to deliver an e-mail 3 hours after abandonment 204. The e-mail address of the sender may be entered in the From: box 206, with a Subject 208, such as “Your My Web Site Shopping Cart”. A message or greeting may be included 210. A link to view the contents of the abandoned shopping cart 212 or proceed to checkout 214 may be provided in the e-mail. A footer or closing message 216 may also be included to thank the shopper and to encourage the shopper to complete the transaction. An unsubscribe link 218 may also be included.

Additional e-mails 220 and 222 may be configured with the same message as the initial e-mail 202, or may be customized. The content may be tailored for each subsequent e-mail to be more persuasive or to attract the abandoner's attention and provide an incentive such as a special offer or coupon to the abandoner to complete the transaction. The additional emails can also be used for data tracking endeavors by the merchant by including a survey or feedback forms in the emails. Optionally, the second 220 and third 222 e-mail may be disabled by selection of the Disable Email box 224. The delivery times may also be set to 48 hours for the second e-mail 220, for example and 7 days for the third e-mail 222.

In the code for each web page from which information will be collected, including the confirmation page, a line of JavaScript is placed such as:

<script language=“JavaScript1.2”src=https://app.secondbitesolutions. com/JCScripts/sbtracking.js?<CLIENTID></script>

This line of code could be developed using technologies other than JavaScript such as Flash or Java.

When a customer enters a page on the ecommerce merchant's web site which includes the preceding JavaScript, the merchant's web page requests JavaScript code from the session server which records a unique customer id, the page currently being viewed, and the time initiated. If the customer is new to the web site then a new record is added to a tracking database. If this is a returning customer, then another record is added for the returning customer. When requested by the merchant's web pages, the JavaScript is dynamically created by server process. The JavaScript on the merchant's web pages then makes HTML image calls (i.e. 1×1 pixel <img> tags) from the consumer's web browser to record the shopping cart and identification information in the session server database. These tracking calls are not limited to HTML image calls but used as an example of a dynamic call back to the session server. Tracking functions are attached to the window.onload and window.onunload events to pass information designated and configured to be captured, to the session server. The events that are used to trigger the sending of the information are not limited to window.onload and window.unload. Other events such as window.onblur can also be used to cause the tracking information to be sent to the server. Thus, if a page is designated as a recording page, as shown hereinabove for FIG. 2, any Form Field, Query, or Cookie Value designated to be captured is passed to the session server through the image tracking calls. Using image tracking calls, information entered into a form on a page on a merchant's web site may be captured even if the page is not submitted. All designated fields may be captured on a window.onunload event and passed to the session server.

This system may be implemented on a merchant's server, or may be implemented and managed by a third party as a service to the merchant. The third party may be compensated based on a percentage of any recovered sales from abandoned shopping carts, on a fee based on the number of emails sent or the number of clicks from an email, or on a flat fee basis.

It is to be understood that while certain forms of this invention have been illustrated and described, it is not limited thereto except insofar as such limitations are included in the following claims and allowable equivalents thereof.

1. A method of recovery of e-commerce information for reinitiation of the check out process comprising the steps of:
a. visiting an e-commerce website,
b. selecting an item for subsequent purchase,
c. collecting and storing an e-mail address and other user information via JavaScript,
d. abandoning the selected item before an order is submitted for the item,
e. delivering a message containing a hyperlink to the e-commerce website to the collected e-mail address,
f. selecting the hyperlink, and
g. returning the user to the e-commerce website with the previously abandoned item restored.

2. The method as set forth in claim 1 wherein said step (c) further includes collecting and storing an e-mail address from a user of the e-commerce website for allowing the user to view the contents of the shopping cart.

3. The method as set forth in claim 1 wherein said step (c) further includes collecting and storing an e-mail address by use of Java, ActiveX, AJAX, or Flash.

4. The method as set forth in claim 1 wherein said step (e) includes a message encouraging the user to select the hyperlink.

5. The method as set forth in claim 1 wherein said step (e) includes delivering a message to the user through banners, online media or instant message.

6. The method as set forth in claim 1 wherein said step (e) includes a message containing a hyperlink to unsubscribe from future e-mails, if the unsubscribe hyperlink is selected, the user's e-mail address is stored in a list to restrict future e-mails to this e-mail address.

7. The method as set forth in claim 1 wherein said step (e) is repeated if the hyperlink is not selected in step (f).

8. The method as set forth in claim 5 wherein said repeated step (e) includes a message including an at least one incentive to the user to select the hyperlink included in the e-mail.

9. The method as set forth in claim 1 wherein said step (c) includes collecting and storing the e-mail address by a third party application service provider.

10. The method as set forth in claim 1 wherein said step (c) includes-collecting and storing the e-mail address locally on the website's servers.

11. The method as set forth in claim 7 wherein said step (e) includes delivering the message by the third party application service provider.

12. The method as set forth in claim 1 wherein said step (c) includes providing the e-mail address to a third party application service provider.

13. The method as set forth in claim 9 wherein said step (e) includes delivering the message by the third party application service provider.

14. The method as set forth in claim 1 further comprising step (b1) presenting a third party application service provider generated block element or pop up window to collect the user's e-mail address.

15. The method as set forth in claim 1 wherein said step (b) includes storing said selected item in an electronic shopping cart.

16. The method as set forth in claim 1 wherein said step (a) includes storing said selected item from a lead generation website.

17. The method as set forth in claim 1 wherein said step (a) includes storing said selected item from a web services website.

18. The method as set forth in claim 1 wherein said step (b) includes storing item information on the user's computer.

19. The method as set forth in claim 15 wherein the item information is stored in a cookie.

20. The method as set forth in claim 15 wherein the item information is stored as a Macromedia Flash MX shared object.

21. The method as set forth in claim 1 wherein said step (d) includes sending a message to the user when the order is submitted by the user without abandoning the order.
